(19) United States
(12) Patent Application Publication
(10) Pub. No.: US 2017/0057033 A1
(43) Pub. Date: Mar. 2, 2017

(54) MULTI AXIS COLUMN MODULE, A METHOD OF SWAPPING TOOLS, AND A METHOD OF ASSEMBLING

(71) Applicant: KENNAMETAL INC., LATROBE, PA (US)

(72) Inventors: CHANDRASHEKHAR KALEGINANAOOR SHARMA, SANJAYNAGAR (IN); ARVIND BANNADI SHETTY, RAJAJINAGAR (IN); DANDA SAINATH ADISE-SHAMURTHY, BANGALORE (IN); KUMARAPPA JAYANNA, BANGALORE (IN)

(21) Appl. No.: 15/351,090

(22) Filed: Nov. 14, 2016

Related U.S. Application Data
(62) Division of application No. 13/388,403, filed on Jun. 15, 2012.

(51) Int. Cl. B23Q 3/157; B23Q 39/02

(52) U.S. Cl. CPC B23Q 3/15746; B23Q 39/026; B23Q 2039/002

(57) ABSTRACT

The disclosure relates to column module, more particularly it is relating to a multi-axis column module. The multi axis column module comprising a support structure of predetermined shape; at least one Automatic Tool Changer [ATC] consisting a tool magazine ensconcing a plurality of tools mounted onto the support structure, a drive unit with a spindle connected to said tool magazine, a gripper arm connected to the spindle of the drive unit; and at least one ram housing having at least one spindle at center and is mounted over the support structure. The disclosure also provides for a method of swapping tools in the multi axis column nodule and method of assembling the multi axis column module.

### RELATED APPLICATIONS

This application claims priority to the U.S. Patent Application associated with Ser. No. 13/388,403, filed Jun. 15, 2012. U.S. patent application Ser. No. 13/388,403 is a national stage entry of and claims priority to PCT Application No. PCT/IN10/00522, filed Aug. 5, 2010. The contents of each of the foregoing applications are incorporated herein by reference in their entireties.

### TECHNICAL FIELD

The disclosure relates to metal cutting machine, more particularly it is relating to a multi axis column module.

### BACKGROUND

Existing column module machines are fitted with either 6 or 8 multi-stations. A turret is mounted on the ram housing which is indexed and powered by motor as illustrated in FIG. 1. The disadvantages of existing multi station turret machines are associated with limitation in number of tools to 6-8. If number of operations in a job is more than 8, it is not possible to carry out in a single setup. The maximum milling/tool diameter in the existing module is also restricted due to tool fouling with the adjacent tools. Thus, the existing column module is less productive due to single spindle working at a time and also increases cost of machine due to high cost of multi station turret.

The machines with one or more spindle have Automatic Tool Changer which is sequential tool change type as illustrated in FIG. 2. The demerits of the two or more 20 spindle machine with sequential tool change type are, the number of activities involved in tool change are more i.e. firstly tool which is present on spindle has to be loaded to tool magazine and then spindle retracts. Subsequently magazine of the machine indexes the required tool and then spindle goes and picks up the tool. Due to the sequential activities, the tool change time is relatively high which results in less productivity. In order to match the productivity, the machines are required to install higher power motors and hence there is an increase in cost of the machine and also operating expenses.

### SUMMARY OF THE INVENTION

Accordingly, the disclosure provides a multi axis column module (1) comprising a support structure (2) of predetermined shape; at least one Automatic Tool Changer [ATC] (3) consisting a tool magazine (4) ensconcing plurality of tools (5) mounted onto the support structure (2), a drive unit (6) connected to said tool magazine (4), a gripper arm (7) connected to the drive unit (6); and at least one ram housing (8) having at least one spindle (9) at center and is mounted over the support structure (2), also provides for a, method of swapping tools in a multi axis column module (1) comprising a support structure (2) of predetermined shape; at least one ATC (3), and at least one ram housing. The at least one ATC consists of or comprises a tool magazine (4) ensconcing a plurality of tools (5) mounted onto the support structure (2), a drive unit (6) connected to said tool magazine (4), and gripper arm (7) connected to the drive unit. The ram housing (8) has at least one spindle (9) at center and is mounted over the support structure (2). Said method comprises acts of positioning ram housing (8) with a spindle (9) to tool change position; rotating gripper arm (7) to a predetermined angle for gripping tool in the spindle (9) and tool magazine (4); de-clamping tool (5) in the spindle (9); swapping of the tools (5) between the spindle (9) and the tool magazine (4); clamping the tool (5) in the spindle (9); and positioning the gripper arm (7) to homing position, and also provides for a method of assembling a multi axis column module (1), said method comprising acts of connecting at least one Automatic Tool Changer [ATC] (3) to a support structure (2); and mounting at least one ram housing (8) having a spindle (9) at center over the support structure (2).

### BRIEF DESCRIPTION OF THE DRAWINGS

The features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 shows column module machine with turret according to prior art,

FIG. 2 shows column module machine with sequential tool change mechanism according to prior art,

FIG. 3a shows Automatic Tool Changer (ATC) according to the disclosure,

FIG. 3b shows Tool Magazine according to the disclosure,

FIG. 3c shows Drive Unit according to the disclosure,

FIG. 3d shows Gripper Arm according to the disclosure,

FIG. 4 shows ram housing according to the disclosure,

FIG. 5a shows a perspective view of a multi axis column module with a single ram housing and a single ATC according to the disclosure,

FIG. 5b shows another perspective view of a multi axis column module with a single ram housing and a single ATC according to the disclosure, [Application example of multi axis column module (1)].

FIG. 6a shows perspective view of a multi axis column module with a single ram housing and a double ATC according to the disclosure,

FIG. 6b shows another perspective view of a multi axis column module with a single ram housing and a double ATC according to the disclosure, [Application example of multi 5 axis column module (1)].

FIG. 7a shows perspective view of multi axis column module with a double RAM housing and double ATC according to the disclosure,

FIG. 7b shows another perspective view of a multi axis column module with a double ram housing and a double ATC according to the disclosure, [Application example of multi 10 axis column module (1)].

FIG. 8 shows front view of tool swapping mechanism according to the disclosure,

FIG. 9 shows chart of various configurations of multi axis column module according to the disclosure,

FIGS. 10a and 10b shows perspective and top views of the multi axis column modules of double column configuration in which column modules are opposite to each other according to the disclosure,

FIGS. 11a and 11b shows perspective and top views of the multi axis column modules of double column configuration in which column modules are adjacent to each other according to the disclosure,

FIGS. 12a and 12b shows perspective and top views of the multi axis column modules of double column configuration in which column modules are at an angle to each other according to the disclosure, and

FIGS. 13a and 13b show top views of the multi axis column modules of multiple column configurations according to the disclosure.

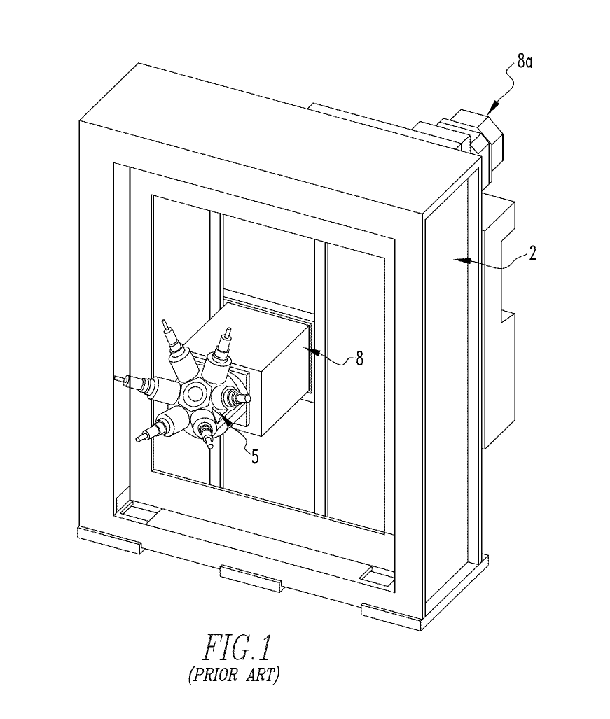

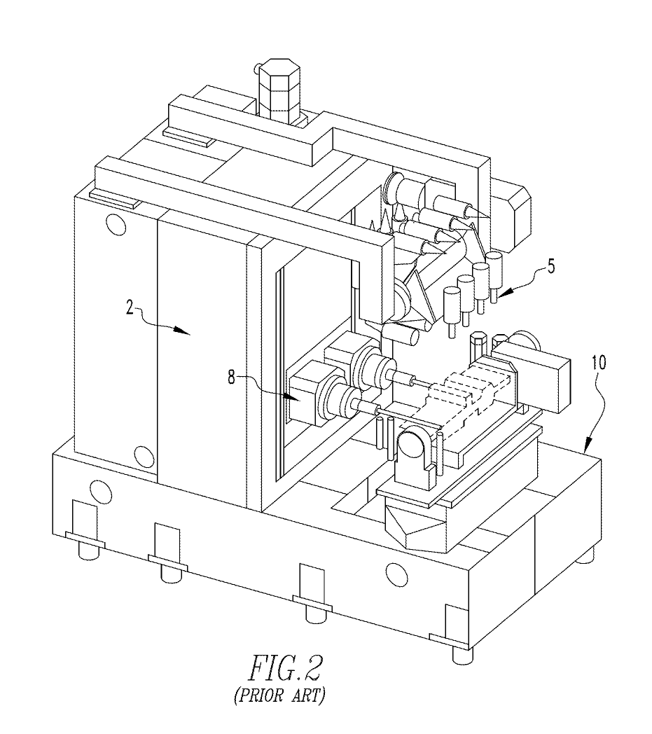

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, and designed in a wide variety of different configurations, all of which are explicitly contemplated and make part of this disclosure.

This disclosure is drawn inter alia to a multi axis column module, method of operating and method of assembling the multi axis column module.

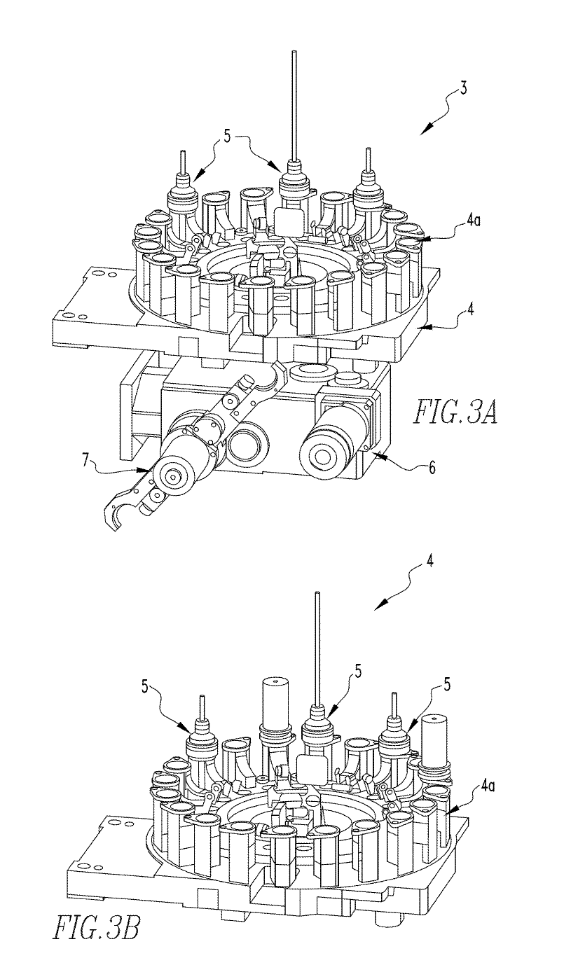

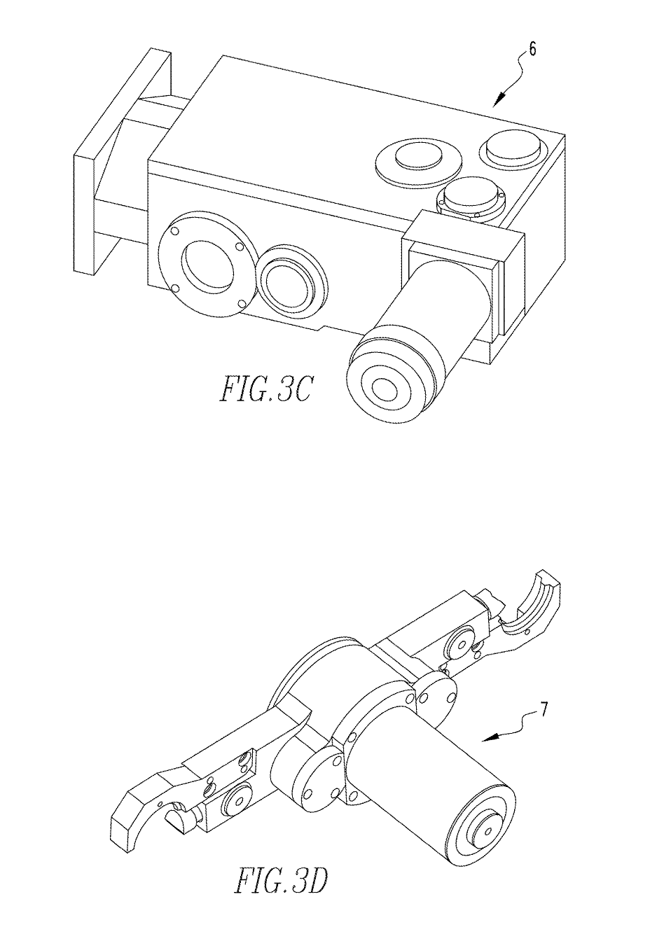

The principal embodiment of the present disclosure provides for a multi axis column module (1) comprising a support structure (2) of predetermined shape; at least one Automatic Tool Changer [ATC] (3) FIG. 3a consisting a tool magazine (4) ensconcing plurality of tools (5) mounted onto the support structure (2), a drive unit (6) connected to said tool magazine (4), a gripper arm (7) connected to the drive unit (6); and at least one ram housing (8) having at least one spindle (9) at center and is mounted over the support structure (2).

In still another embodiment of the disclosure the support structure (2) is rectangular in shape provided with guide elements (2a) for movement of the ram housing (8).

In yet another embodiment of the disclosure the tool magazine (4) comprises plurality of tool pockets (4a) ranging from 12 to 24 for ensconcing the tools (5).

In yet another embodiment of the disclosure the gripper arm (7) has at least one gripper at ends of the gripper arm (7) for clamping the tools (5) during swapping in between the tool magazine (4) and the spindle (9).

In yet another embodiment of the disclosure the ram housing (8) is driven to move using a ball screw mechanism.

In yet another embodiment of the disclosure the spindle (9) is driven by a drive mechanism (8a) fixed at rear end of the ram housing (8).

In yet another embodiment of the disclosure the column module (1) is optionally provided with two spindles in a single ram housing (8) driven by drive mechanism.

In yet another embodiment of the disclosure the column module (1) is optionally provided with two ram housings (8) driven independently by drive mechanism, wherein each ram housing (8) has one independent spindle (9).

In yet another embodiment of the disclosure a multi station machine comprising plurality of multi axis column modules (1) configured in a predetermined manner.

In yet another embodiment of the disclosure the multi axis column modules (1) are configured to form double column module, multi column module and column module at an angle.

One more main embodiment of the disclosure provides for a method of swapping tools in a multi axis column module (1) comprising a support structure (2) of predetermined shape; at least one ATC (3), and at least one ram housing. The at least one ATC consists of or comprises a tool magazine (4) ensconcing a plurality of tools 95) mounted onto the support structure (2), a drive unit (6) connected to said tool magazine (4), and a gripper arm (7) connected to the drive unit. The ram housing (8) has at least one spindle (9) at center and is mounted over the support structure (2). Said method comprises acts of: positioning ram housing (8) with a spindle (9) to tool change position; rotating gripper arm (7) to a predetermined angle for gripping tool in the spindle (9) and tool magazine (4); de-clamping tool (5) in the spindle (9); swapping of the tools (5) between the spindle (9) and the tool magazine (4); clamping the tool (5) in the spindle (9); and positioning the gripper arm (7) to homing position.

In yet another embodiment of the disclosure the gripper arm (7) is rotated to about 1800 to swap the tools (5) from the magazine (4) and the spindle (9).

Another main embodiment of the disclosure provides for a method of assembling a multi axis column module (1), said method comprising acts of connecting at least one Automatic Tool Changer [ATC] (3) to a support structure (2); and mounting at least one RAM housing (8) having a spindle (9) at center over the support structure (2).

In yet another embodiment of the disclosure the method comprise an act of placing plurality of multi axis column modules (1) with reference to a fixture (10) to configure column module selected from a group comprising single column module, double column module, multi column module and column module at an angle.

FIG. 3a illustrates Automatic Tool Changer (ATC) according to the disclosure. The ATC is used in CNC machine tool consists of a tool magazine (4) which stores the tools (5), drive unit (6) for indexing the tool magazine (4) and a double gripper arm (7).

FIG. 3b illustrates Tool Magazine (4) according to the disclosure. The tool magazine (4) ensconces the plurality of various kinds of tools (5) for carrying out various operations using the machine. The tools (5) are housed in tool pockets (4a). The 5 magazine (4) is made as circular shape which helps in indexing suitable tool during tool swapping operation.

FIG. 3c illustrates Drive Unit (6) according to the disclosure. The drive unit (6) transmits motion to the gripper arm (7) for rotating for swapping operation to change the tools (5) in between the tool magazine (4) and spindle (9) of the machine.

FIG. 3d illustrates Gripper Arm (7) according to the disclosure. The gripper arm (7) has at least one gripper at its ends to hold/clamp the tools (5) during tool changing. The grippers are also used to de-clamp the tools (5) during the tool swapping operation.

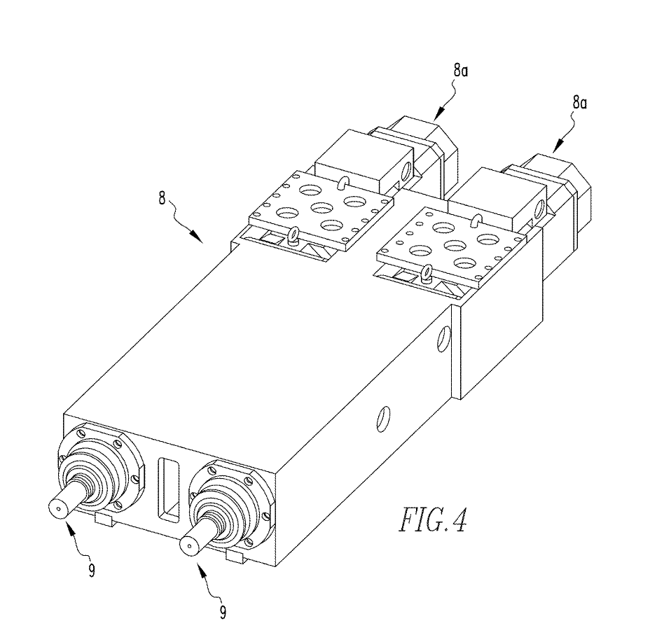

FIG. 4 illustrates ram housing (8) according to the disclosure. The ram housing (8) is a sliding unit closely guided to achieve the defined axis using linear motion guides. The ram housing (8) moves along defined axis through ball screw mechanism. The ram housing also houses the spindle (9) of the machine which is used to rotate the 20 tool during machining operations.

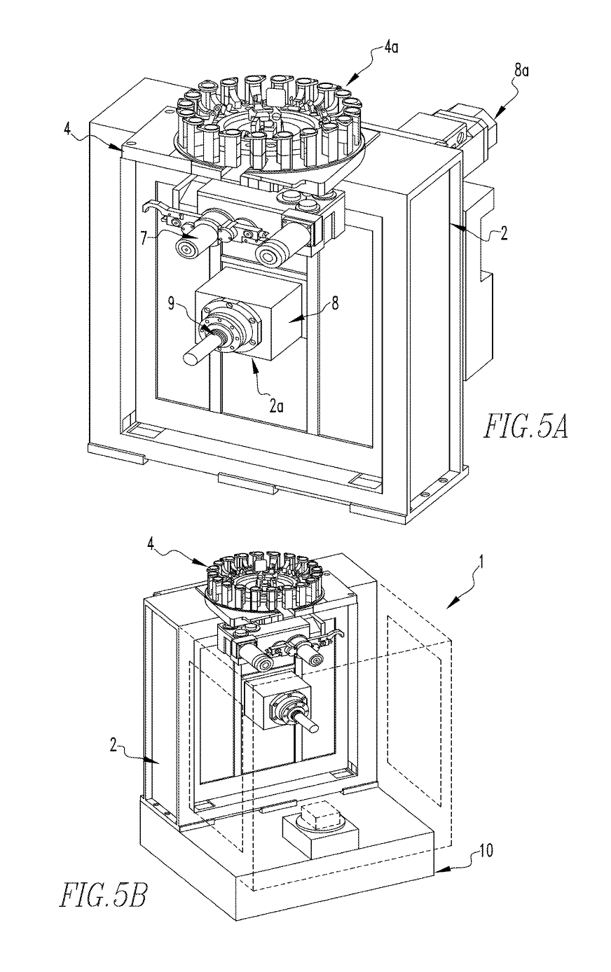

FIGS. 5a and 5b illustrates perspective views multi axis column module with single ram housing (8) and single ATC (3) according to the disclosure. It consists of single spindle (9) powered by drive mechanism (8a), preferably motor mounted on the ram housing (8) and double gripper arm (7) type ATC (3) mounted on the top of the multi axis column module (1). All the moving slides are mounted on the fixed to supporting structure (2) on top of this double gripper arm type ATC (3) is mounted. Whenever the tool change command is provided the spindle (9) comes out of working zone i.e. to tool change position and ATC (3) changes the required tool. The spindle (9) comes back to next operation. The column module (1) is configured to build different purpose machines to machine various components.

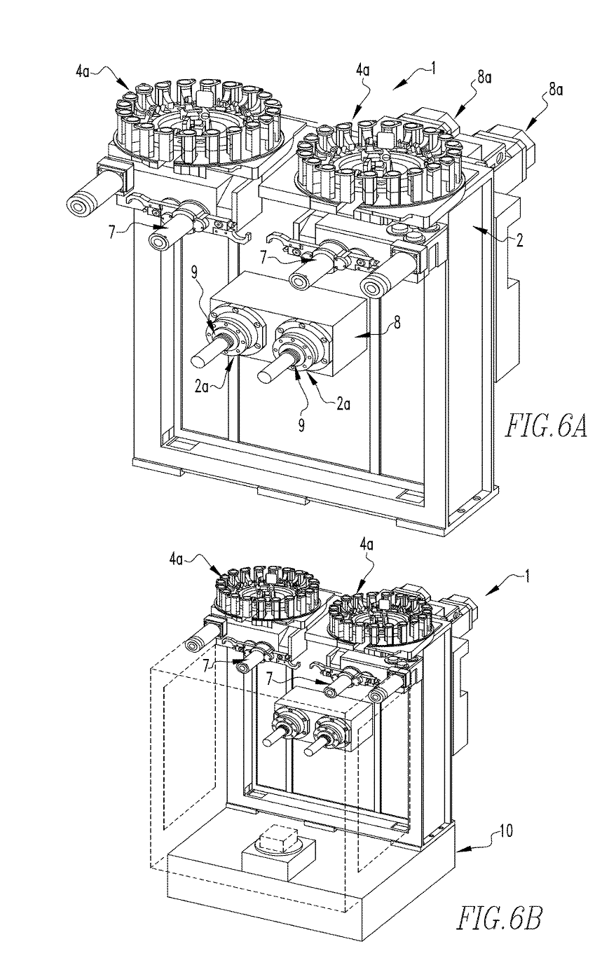

FIGS. 6a and 6b illustrates perspective views of multi axis column module with single ram housing and double ATC according to the disclosure. It consists of two spindles (9) powered by independent drive mechanisms/motors (8a) mounted on the common feed of the ram housing (8). Two ATCs (3) are mounted on the top of the multi axis CNC column module (1).

All the moving slides are mounted on the fixed support structure (2) on top of this two numbers of ATCs are mounted. During tool change operation the spindles (9) comes out of working zone i.e. to tool change position and ATCs changes the required tool (5). Tool change takes place simultaneously to reduce the time taken during changing the tools (5). The spindles (9) come back to another position for carrying out next operation. The module (1) is configured to build different purpose machine to machine various components and requirements.

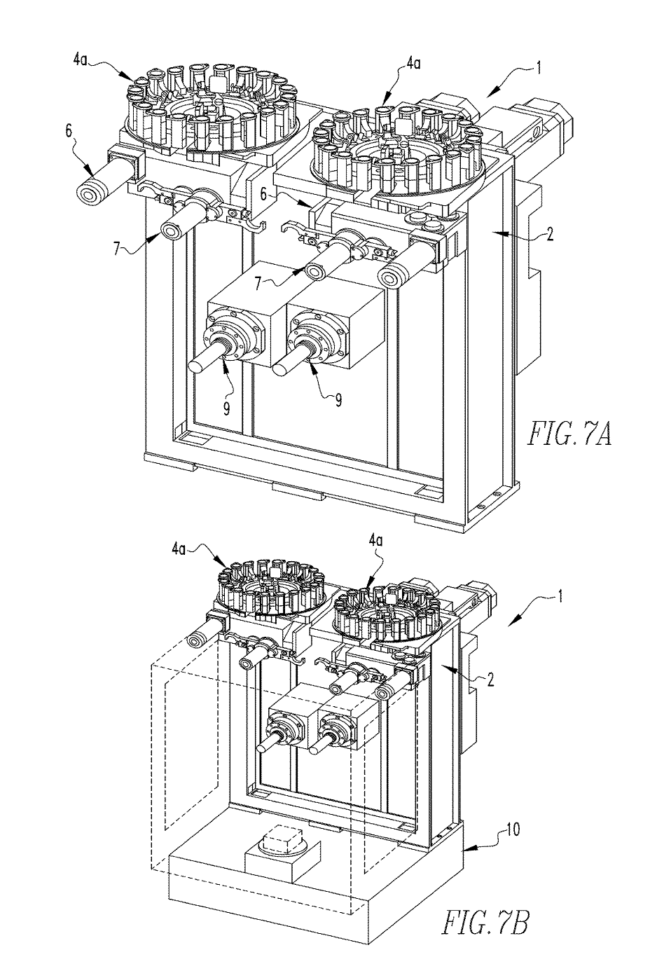

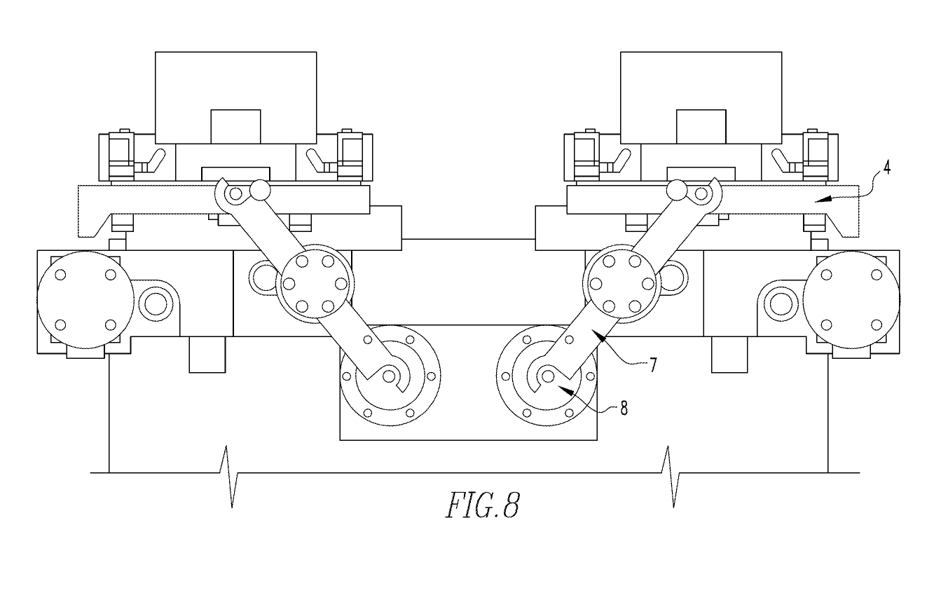

FIGS. 7a and 7b illustrates perspective views of multi axis column module with double ram housing and double ATC according to the disclosure. It consists of two spindles (9) powered by independent drive mechanisms/motors (8a) mounted on the independent feed ram housing (8). Two ATCs (3) are mounted on the top of the multi axis column module (1). All the moving slides are mounted on the fixed support structure (2) on top of it two ATCs are mounted. When the tool change command is given spindles (9) comes out of working zone i.e. to tool change position and ATCs (3) changes the required tool (5). Tool change takes place simultaneously and then spindles (9) come back to next position for operation. The module (1) is configured to build different machines to machine various components and requirements.

FIG. 8 illustrates front view of tool swapping mechanism according to the disclosure. The swapping mechanism comprises steps of moving/positioning machine tool spindle (9) to tool change position, clamping double gripper arm (7) to the tools between spindle (9) and magazine (4), de-clamping tool (5) in the spindle (9), pulling out tools (5) from the spindle (9) and magazine (4) using double gripper arm (7), rotating double gripper arm (7) to an angle about 180 degrees, pushing the changed tools (5) into the spindle and magazine (4) by using the double gripper arm (7) and parking/homing the double gripper arm (7).

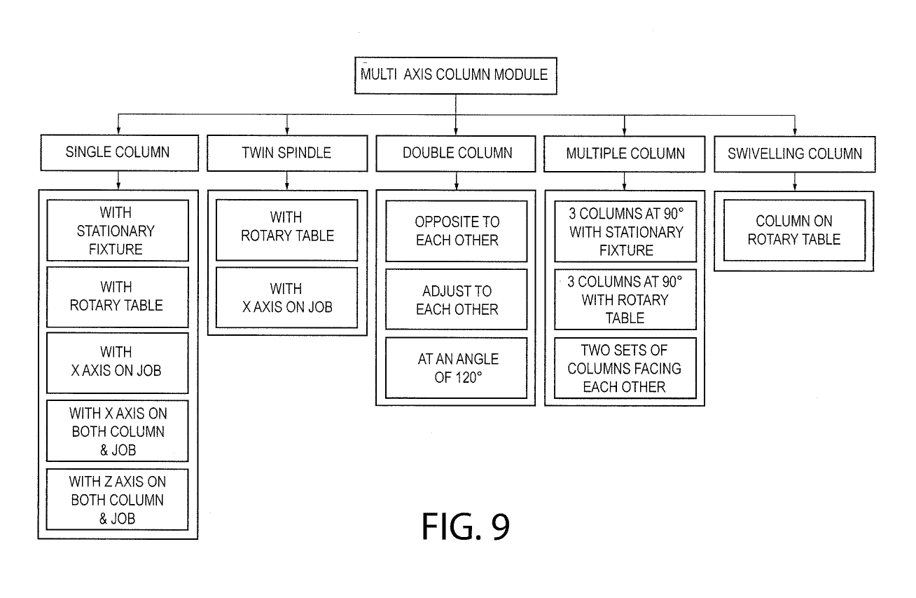

FIG. 9 illustrates chart providing various configurations of multi axis column module according to the disclosure.

One configuration obtained in multi axis column module is single column module. The configuration can have stationary fixture (10) or rotary table or x-axis on job or with axis on both column and job or with z-axis on both column and job.

Another configuration obtained in multi axis column module is twin spindle column module. The configuration can have rotatable table or with x-axis on job.

Another configuration obtained in multi axis column module is double column module.

The module comprises two single spindle modules facing/opposite to each other or modules placed adjacent to each other or the modules at an angle of about 120 degrees.

Another configuration obtained in multi axis column module is multi column module.

The module comprises 3 columns at 90 degrees to each other with stationary fixture or with rotary table or with two sets of columns facing each other.

Another configuration obtained in multi axis column module is swiveling column. The swiveling column comprises column on rotary table.

The technology of the instant disclosure is further elaborated with the help of following examples. However, the examples should not be construed to limit the scope of the invention.

### EXAMPLE 1

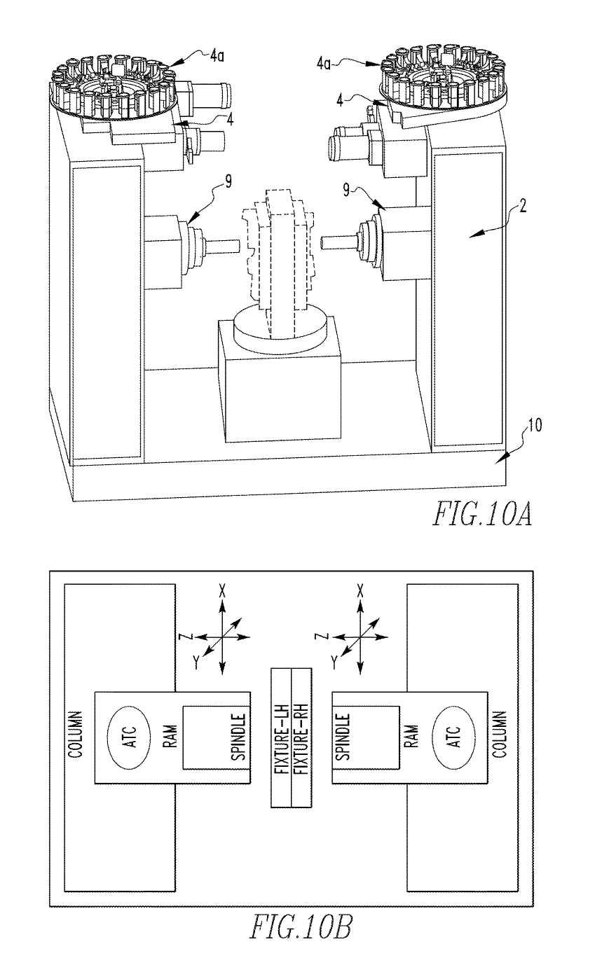

FIGS. 10a and 10b illustrates perspective and top views of the multi axis column modules of double column configuration in which column modules are opposite to each other according to the disclosure. The configuration is double column module. The module comprises two single spindle modules facing/opposite to each other. The module can operate at distances of 400 mm in all three axes, i.e. x-axis 400 mm, y-axis 400 mm, z-axis 400 mm. The ATC (3) comprises 20 tools per column module.

### EXAMPLE 2

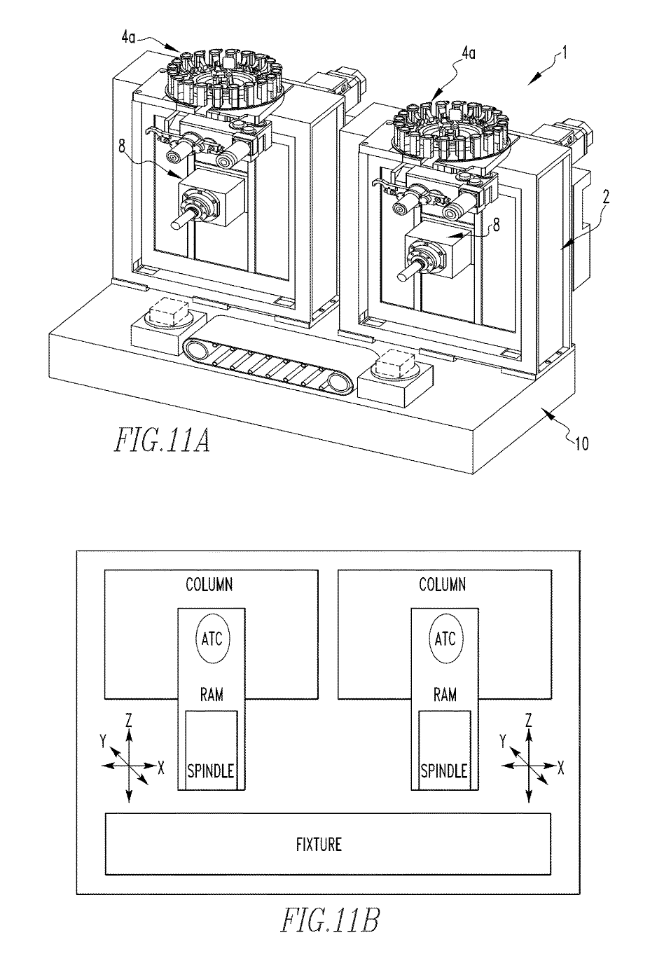

FIGS. 11a and 11b illustrates perspective and top views of the multi axis column modules of double column configuration in which column modules are adjacent to each 35 other according to the disclosure. The configuration is double column module. The module comprises two single spindle modules placed side by side to each other. The module can operate at distances of 400 mm in all three axes, i.e. x-axis 400 mm, y-axis 400 mm, z-axis 400 mm. The ATC (3) comprises 20 tools per column module.

### EXAMPLE 3

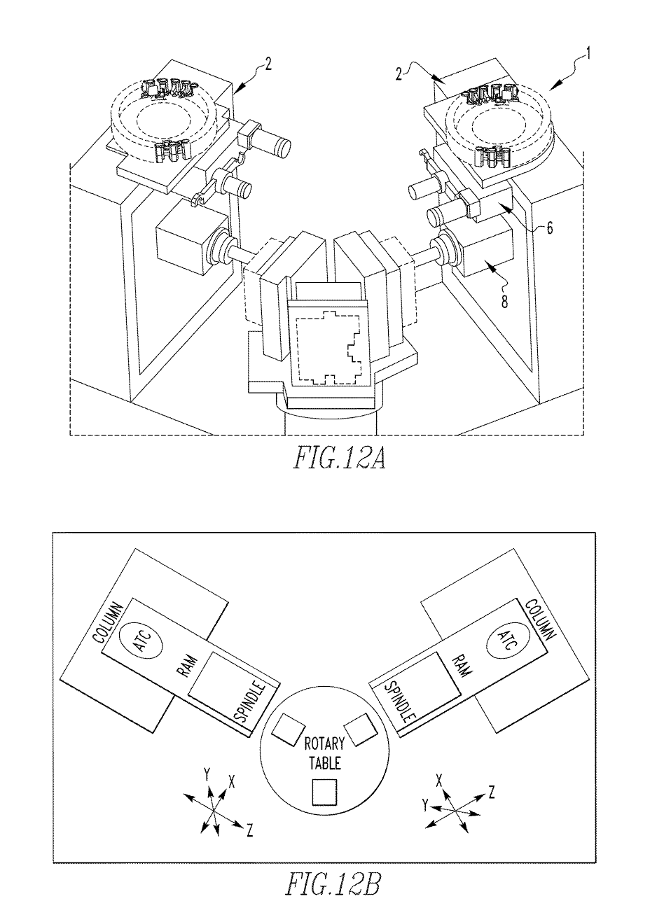

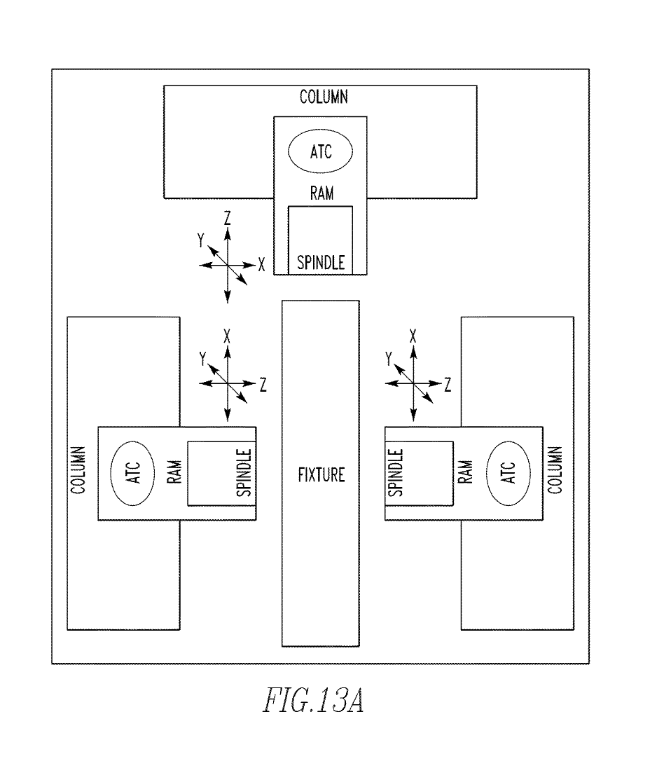

FIGS. 12a and 12b illustrates perspective and top views of the multi axis column modules of double column configuration in which column modules are swiveled to each other according to the disclosure. The configuration is double column module. The module comprises two single spindle modules at an angle of about 120 degrees to each other. The module can operate at distances of 400 mm in all three axes, i.e. x-axis 400 mm, y-axis 400 mm, z-axis 400 mm. The ATC (3) comprises 20 tools per column module.

### EXAMPLE 4

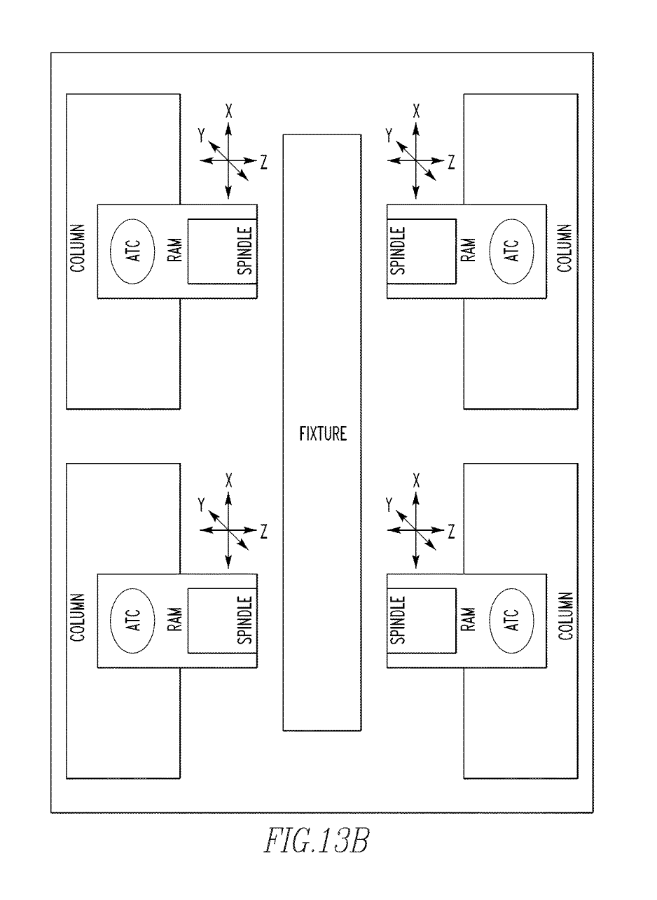

FIGS. 13a and 13b illustrate top views of the multi axis column modules of multiple column configurations according to the disclosure. The column module is multi column module. The configuration comprises 3 columns at 90 degrees to each other with stationary fixture (FIG. 13a) and with two sets of columns facing each other (FIG. 13b). The module can operate at distances of 400 mm in all three axes, i.e. x-axis 400 mm, y-axis 400 mm, z-axis 400 mm. The ATC (3) comprises 20 tools per column module.

Advantages: More productivity due to two spindles working at a time, simultaneous tool change takes for both the spindles with the help of double gripper arm type ATC, 25 tool change time of other spindle is masked i.e. overlapped with the first spindle, tool change time thus saved is used for increasing the productivity, more utilization of the machine, the floor space is reduced due to two spindle single machine producing output of two machines, operators walking distance is reduced and reduction in additional capital Investment.

Using two spindles and two double gripper arm type ATC configuration module, productivity is doubled for the identical components with the minimum additional investment. Different faces of the components are machined in a single setup. Machines are easily configured and built using these column modules as per requirement and integrated into the production line. Flexibility and easy to configure the module in to multi-station machine are also achieved for machining of various components and operations.

### REFERRAL NUMERALS

1: multi axis column module,

2: support structure,

2a: guide element,

3: Automatic Tool Changer,

4: Tool Magazine,

4a: Tool Pockets,

5: Tools,

6: Drive Unit,

7: Gripper Arm,

8: RAM Housing,

8a: drive mechanism,

9: Spindle in the RAM housing, and

10: Fixture.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, Band C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, Band C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A multi axis column module comprising:
a support structure of predetermined shape;
at least one Automatic Tool Changer comprising:
a tool magazine structured to house a plurality of tools, the tool magazine mounted on the support structure so as to be rotatable about a first axis,
a drive unit connected to said tool magazine, and
a gripper arm connected to the drive unit, the gripper arm structured to transfer tools from the tool magazine; and
at least one ram housing mounted on the support structure, the at least one ram housing having at least a first spindle and a second spindle structured to receive tools from the gripper arm.

2. The multi axis column module of claim 1, wherein the support structure is rectangular in shape and is provided with guide elements for movement of the at least one ram housing.

3. The multi axis column module of claim 1, wherein the tool magazine comprises a plurality of tool pockets ranging in number from 12 to 24 for housing the plurality of tools.

4. The multi axis column module of claim 1, wherein at least one of the first spindle and the second spindle is driven by a drive mechanism fixed at a rear end of the first spindle and/or the second spindle.

5. A multi station machine comprising a plurality of multi axis column modules as recited in claim 1 configured in a predetermined manner.

6. The multi station machine of claim 5, wherein the plurality of multi axis column modules are configured to form one of a: double column module, a multi column module, and a column module at an angle.

7. A multi axis column module comprising:
a support structure of predetermined shape;
at least one Automatic Tool Changer comprising:
a tool magazine structured to house a plurality of tools, the tool magazine mounted on the support structure so as to be rotatable about a first axis,
a drive unit connected to said tool magazine, and
a gripper arm connected to the drive unit, the gripper arm structured to transfer tools from the tool magazine; and
a first ram housing mounted on the support structure, the first ram housing having at least a first spindle structured to receive tools from the gripper arm; and
a second ram housing mounted on the support structure, the second ram housing having at least a second spindle structured to receive tools from the gripper arm,
wherein the first ram housing and the second ram housing are independently driven by a drive mechanism.

8. The multi axis column module of claim 7, wherein the support structure is rectangular in shape and is provided with guide elements for movement of the at least one ram housing.

9. The multi axis column module of claim 7, wherein the tool magazine comprises a plurality of tool pockets ranging in number from 12 to 24 for housing the plurality of tools.

10. A multi station machine comprising a plurality of multi axis column modules as recited in claim 7 configured in a predetermined manner.

11. The multi station machine of claim 10, wherein the plurality of multi axis column modules are configured to form one of a: double column module, a multi column module, and a column module at an angle.

12. A method of swapping tools in a multi axis column module as recited in claim 1, the method comprising:
positioning the ram housing with the spindle in a tool change position;
rotating the gripper arm to a predetermined angle for gripping a tool in the spindle and a tool in the tool magazine;
gripping a tool disposed on the spindle and a tool housed in the magazine with the gripper arm;
rotating the gripper arm to swap the tools between the spindle and the tool magazine; and
positioning the gripper arm to a homing position.

13. The method of claim 12, wherein rotating the gripper arm to swap the tools between the spindle and the tool magazine comprises rotating the gripper arm about 180°.
